(19) United States
(12) Patent Application Publication
(10) Pub. No.: US 2026/0177096 A1
(43) Pub. Date: Jun. 25, 2026

(54) SCREW ELEMENT, OPERATING TOOL, USE AND FORMING TOOL

(71) Applicant: SPAX International GmbH & Co. KG, Ennepetal (DE)

(72) Inventors: Markus Kamrowski, Wetter (DE); Klaus Kroesen, Xanten (DE); Viktor Ölke, Salzbergen (DE)

(21) Appl. No.: 19/426,740

(22) Filed: Dec. 19, 2025

(30) Foreign Application Priority Data
Dec. 20, 2024 (DE) 102024139491.9
May 15, 2025 (DE) 102025118779.7

(51) Int. Cl. F16B 35/06; F16B 23/00

(52) U.S. Cl. CPC F16B 35/06; F16B 23/003

(57) ABSTRACT

A screw element with a force application point for an actuating tool. The force application point has a plurality of projections and recesses arranged distributed on a circumference around a central axis, which merge into one another alternately. The projections and the recesses are formed with a curved shape and each extend parallel to the central axis in an insertion section. A conical section is arranged in an end region of the force application point and a chamfer surrounding the conical section extends between the conical section and the insertion section. Furthermore, the invention relates to an actuating tool with an actuating section, a use, and a forming tool for manufacturing a force application point or an actuating section.

### CROSS REFERENCE TO RELATED APPLICATION

The present application claims the priority benefits of German patent application nos. DE 10 2024 139 491.9, filed on Dec. 20, 2024, and DE 10 2025 118 779.7, filed on May 15, 2025, both of which are incorporated herein by reference in their entireties.

### BACKGROUND AND FILED OF THE INVENTION

The invention relates to a screw element with a force application point for an actuating tool, wherein the force application point has a plurality of projections and recesses arranged distributed on a circumference around a central axis. The projections and the recesses merge into one another alternately. The projections and the recesses are formed with a curved shape. The projections and the recesses each extend parallel to the central axis in an insertion section. Furthermore, the invention relates to an actuating tool for a screw element, a use, and a forming tool.

Screw elements with force application points are known in the prior art in a variety of configurations. The term “screw element” encompasses all screwable components, such as screws, nuts, or bolts. In the prior art, different designs of force application points are known that enable efficient transmission of torque to the screw element. Common forms include internal hexagon or external hexagon profiles as well as the so-called internal hex-round (also known under the brand name “TORX®”), which is characterized by a star-shaped contour with rounded corners. The internal hex-round offers in particular the advantage of improved torque transmission and reduced wear of an actuating tool.

Despite these developments, however, there continues to be a need for alternative forms of force application points that enable even more efficient torque transmission, improved service life, and good compatibility with various actuating tools.

### SUMMARY OF THE INVENTION

The present invention provides a screw element and an actuating tool that ensure improved torque transmission with the best possible compatibility with known force application points.

The aforementioned object is solved in embodiments of the invention in which a generic screw element comprises a conical section that is formed in an end region of the force application point and that a chamfer surrounding the conical section extends between the conical section and the insertion section.

The screw element according to the invention is, for example, a screw, in particular a universal screw or a wood screw, a nut, a bolt, or a similar element to which torque can be transmitted by means of a force application point. The term screw element is also intended to encompass such components that fulfill a function through an effected rotation, for example closing and locking valves. The force application point is formed, for example, as an internal profile, i.e., penetrating into the screw element, or as an external profile, i.e., protruding from the screw element. The associated actuating tool is advantageously formed geometrically compatible with an internal profile or an external profile. The actuating tool is in particular formed complementary to the force application point of the screw element.

If the screw element is formed as a screw, the screw preferably has a screw head, a shank connected to the screw head, and a tip. The shank has a thread that extends at least partially or completely along the shank. The screw head preferably transitions into the shank or a shank projection with a conical surface. The shank projection is at least partially cylindrical and has an end face oriented orthogonally to the central axis. Preferably, the shank projection is formed free of a thread. Optionally, it is provided that the shank is at least partially formed as a friction shank.

It is preferably provided that the force application point is oriented substantially parallel to a central axis of the screw element. According to a preferred embodiment, a central axis of the screw element coincides with a central axis of the force application point.

The force application point of the screw element has a plurality of projections and recesses arranged distributed on a circumference around a central axis of the force application point, in particular around a central axis of the screw element. The projections and the recesses are arranged alternately to one another along the circumference of the force element. The projections and the recesses merge into one another. A projection and a recess adjacent to the projection merge into one another in a transition. Preferably, the transition is formed free of points and edges. In particular, in the transition, a tangent to the projection is identical to a tangent to the recess adjacent to the projection.

The projections are formed with a curved shape, for example circular segment-shaped or elliptical segment-shaped. It is further provided that the recesses are formed curved, for example circular segment-shaped or elliptical segment-shaped. Also, one or more of the projections and/or one or more of the recesses can have a curved shape with irregular curvature. For example, the projections and/or the recesses have, in a plane to which the central axis is a plane normal, a cross-section that is curved convex or concave with respect to the central axis. In particular, it is provided that the projections are circular segment-shaped and the recesses are circular segment-shaped. In particular, the force application point is formed as an internal or external hex-round.

It is expediently provided that the radii of the circles underlying the circular segment-shaped projections and the circular segment-shaped recesses are different. Preferably, a circular segment-shaped projection has a smaller radius than a circular segment-shaped recess. It is also possible that a circular segment-shaped projection has the same radius as a circular segment-shaped recess. Alternatively, it is provided that a radius of the projections is identical to a radius of a recess.

The projections and the recesses each extend parallel to the central axis in an insertion section. Tolerance deviations due to the selected manufacturing process remain unconsidered in the screw element according to the invention. Preferably, each of the projections and each of the recesses extends parallel to the central axis over the complete insertion section. In the axial direction, the projections and the recesses in the insertion section are in particular formed such that both the projections and the recesses are free of an inclination to the central axis. If the projections are circular segment-shaped, the projections have enveloping circles that are constant in the axial direction in the insertion section. If the recesses are circular segment-shaped, the recesses have enveloping circles that are constant in the axial direction in the insertion section. Because the projections and the recesses each extend parallel to the central axis, reliable interaction between the screw element and actuating tool is ensured within manufacturing tolerances.

The force application point has an end region in which a conical section is arranged. The end region of the force application point is arranged, for example, in an internal profile at a section of the force application point opposite the insertion section. In an external profile, the end region is arranged at an insertion section.

The conical section is in particular formed as a cone tip. It is preferably provided that a tip of the cone tip is arranged on the central axis. Alternatively, it is in particular provided that the conical section is formed as a truncated cone. Here, it is preferred that an imaginary tip of the conical section is arranged on the central axis.

To simplify the manufacture of the screw element, it is in particular further provided that the conical section has a closed circumferential contour. Preferably, the conical section is formed rotationally symmetrical about the central axis.

Alternatively, it is provided that a curved section is arranged in the end region of the force application point. The curved section has an envelope curve different from a cone. For example, it is provided that the curved section is formed as a paraboloid or as a paraboloid segment. The paraboloid can be formed as a paraboloid of revolution or as an elliptical paraboloid. If a curved section is arranged in the end section of the force application point, it is preferred that a vertex of a curved section or a fictitious vertex of a curved section is arranged on the central axis. In particular, it is provided that, apart from the envelope curve, the curved section is formed exactly like the conical section, i.e., has the same features.

According to the invention, it is further provided that a chamfer surrounding the conical section extends between the conical section and the insertion section. It is preferably provided that the chamfer surrounds the conical section at least in sections, preferably completely, in the circumferential direction. In the context of the present invention, the chamfer surrounds the conical section when the chamfer is at least partially arranged at a circumferential section of the conical section. In particular, it is provided that the conical section has a base area that is smaller than or equal to a minimum cross-section of the chamfer, preferably that the conical section does not protrude beyond the chamfer.

Alternatively or additionally, it is in particular provided that a fictitious base area, for example a maximum diameter, of the chamfer is smaller than or equal to a fictitious envelope curve around the projections, preferably that the chamfer does not protrude beyond the projections. The chamfer preferably has an inclination different from the conical section. For uniform force distribution, it is in particular provided that the chamfer is formed rotationally symmetrical about the central axis.

The invention has the advantage over screw elements with known force application points that a penetration depth of an actuating tool into the force application point or of the force application point into an actuating tool can be influenced. Through the conical section with the surrounding chamfer, for example, an actuating tool is advantageously introduced into the force application point and centered. If, for example, the projections and recesses are formed in the shape of an internal hex-round, there is advantageous compatibility of the force application point with actuating tools with external hex-round profile or T-Star® plus profile.

According to one embodiment of the screw element, it is provided that the chamfer surrounding the conical section intersects with the projections and/or with the recesses. In particular, it is provided that the chamfer surrounding the conical section intersects at least partially or completely with the projections and with the recesses. Preferably, the chamfer transitions into the projections and optionally the recesses. It is in particular provided that the chamfer represents a limitation of the projections and/or the recesses in the axial direction.

It is particularly preferably provided that the chamfer has a first, in particular truncated cone-shaped, section that intersects with the projections and the recesses, and that the chamfer has at least one second, in particular truncated cone-shaped, section that is not intersected by the recesses or projections. Preferably, the second section is limited in the axial direction by a vertex circle on which all vertices of the projections or recesses lie and by a base area of the conical section. It is preferably provided that the second section directly adjoins the conical section.

Because preferably the projections and the recesses of the force application point extend to the chamfer, the effective area of the force application point for force transmission for an actuating tool is increased by up to about 20% compared to known force application points. In addition, the chamfer advantageously increases the service life of an actuating tool by reducing the cam-out effect.

It is particularly preferably provided that the chamfer directly adjoins the insertion section. Due to the combination of a conical section in an end region of the force application point and a chamfer surrounding the conical section that intersects the projections and/or the recesses, one can also speak of a double-chamfered tip of the force application point. Through this advantageous, double-chamfered structure, the effective area between the force application point and actuating tool is enlarged, which increases the transmittable torques.

According to a further embodiment, it has proven advantageous when it is provided that the chamfer surrounding the conical section opens into the conical section. The chamfer is thus arranged directly adjacent to the conical section. Such an embodiment makes it possible to optimize the installation space required for the force application point.

A further embodiment of the screw element provides that a chamfer angle that the chamfer encloses with the central axis is smaller than a cone angle that the conical section encloses with the central axis of the force application point. In particular, it is provided that the chamfer angle extends between an outer surface of the chamfer and the central axis.

Alternatively or additionally, it is provided that the cone angle extends between an outer surface of the conical section and the central axis of the force application point. Because the chamfer angle is smaller than the cone angle, the chamfer is more inclined than the conical section, whereby the effective area of the force application point for force transmission for an actuating tool is improved. Preferably, the chamfer angle is between 30° and 60°, preferably between 40° and 50°, more preferably about 45°. In particular, the cone angle is between 55° and 85°, preferably between 65° and 75°, particularly preferably about 70°.

As an alternative to the preceding embodiment, it is provided that the chamfer has at least one first chamfer section and at least one second chamfer section. The first chamfer section encloses in particular a first chamfer angle with the central axis and the second section encloses in particular a second chamfer angle with the central axis. Preferably, the first chamfer section transitions into the conical section and the second chamfer section transitions into the insertion section. The first chamfer angle and the second chamfer angle are different. In particular, the first chamfer angle is smaller than the second chamfer angle, preferably the second chamfer angle is greater than twice as large as the first chamfer angle. For example, the first chamfer angle is less than 30°, in particular less than 29°, preferably less than 28°. It is in particular provided that the first chamfer angle is between 25° and 28°, in particular exactly 28°. For example, the second chamfer angle is more than 60°, in particular more than 62°, preferably more than 63°. It is in particular provided that the second chamfer angle is between 62° and 68°, in particular exactly 62°.

It is preferably provided that a length of the first chamfer section along the central axis is longer than a length of the second chamfer section along the central axis.

For example, it is further provided that the chamfer further has at least one third chamfer section and at least one fourth chamfer section. The third chamfer section encloses a third chamfer angle with the central axis and the fourth chamfer section encloses a fourth chamfer angle with the central axis. The third chamfer angle and the fourth chamfer angle are different. Preferably, the first chamfer angle and the third chamfer angle and/or the second chamfer angle and the fourth chamfer angle are equal. It is preferably provided that the conical section is followed by the first chamfer section, then the second chamfer section, then the third chamfer section, then the fourth chamfer section, and then the insertion section.

In particular, the third chamfer angle is smaller than the fourth chamfer angle, preferably the fourth chamfer angle is greater than twice as large as the third chamfer angle. For example, the third chamfer angle is less than 30°, in particular less than 29°, preferably less than 28°. It is in particular provided that the third chamfer angle is between 25° and 28°, in particular exactly 28°. For example, the fourth chamfer angle is more than 60°, in particular more than 62°, preferably more than 63°. It is in particular provided that the fourth chamfer angle is between 62° and 68°, in particular exactly 62°.

In this embodiment, the chamfer is in particular at least single-stage, preferably two-stage. This embodiment has the advantage over the prior art that compatibility with known force application points is further increased.

A further embodiment of the screw element provides in particular that the chamfer is at least partially formed concave or convex curved. The chamfer, which extends between the insertion section and the conical section, is preferably formed convex and/or concave curved in cross-section over part of its extension along the longitudinal axis, in particular over the complete extension. Such a chamfer can be advantageously manufactured. In particular, it is provided that the chamfer has at least two chamfer sections with concave or/and convex curvature. It is preferably provided that the convex or concave curvature is formed by circular, arc-shaped, or spline-shaped curved areas. Circular curved areas have a constant radius.

It has also proven advantageous when, according to a further embodiment, it is provided that a maximum length of the chamfer along the central axis is greater than a maximum length of the conical section along the central axis. A length along a central axis corresponds to a longitudinal extension that is measured parallel to the central axis. It is preferably provided that the maximum length of the chamfer along the central axis is at least 1.2 times, preferably at least 1.5 times, preferably at least twice as large as the maximum length of the conical section along the central axis. This ratio results in an advantageous dimensioning of the force application point.

Depending on the configuration of the force application point as an internal profile or as an external profile, it is provided in the insertion section to improve force transmission that a maximum length of one of the recesses or a maximum length of one of the projections along the central axis is greater than a maximum length of the chamfer along the central axis. In particular, when the force application point is formed as an internal profile, a maximum length of the recesses along the central axis is greater than a maximum length of the chamfer along the central axis. Preferably, a maximum length of all recesses and/or all projections along the central axis is greater than a maximum length of the chamfer along the central axis. In particular, it is provided that the maximum length of one or all recesses, respectively one or all projections, along the central axis is 1.5 times, preferably 1.6 times, preferably at least twice as large as the maximum length of the chamfer along the central axis. In particular, a maximum length of the insertion section along the central axis is longer than the maximum extension of the chamfer along the central axis. In particular, the insertion section along the central axis is at least twice as long as the chamfer and/or the conical section.

A balanced ratio of a penetration depth of the actuating tool into the force application point or of the force application point into an actuating tool and a compact installation space is achieved when, depending on whether the force application point is formed as an internal profile or as an external profile, it is in particular provided that the chamfer extends along the central axis in extension of one of the projections, in particular of a vertex of one of the projections, and/or that the chamfer extends along the central axis in extension of one of the recesses, in particular of a vertex of one of the recesses.

In particular when the force application point is formed as an internal profile, a length of the chamfer in extension of one of the projections can be smaller than a maximum length of the chamfer along the central axis. It has proven advantageous when the axial length of the chamfer along the central axis in extension of one of the projections or one of the recesses is arranged at a vertex of the corresponding projection or the corresponding recess. For example, the length of the chamfer along the central axis in extension of one of the projections or one of the recesses is a minimum length of the chamfer along the central axis.

For example, it is provided that the length of the chamfer along the central axis in extension of the projections or the recesses is between 5% and 25% of a maximum extension of the chamfer along the central axis. Alternatively or additionally, it is provided that the length of the chamfer along the central axis is at most 25%, preferably at most 20%, preferably at most 15%, more preferably at most 10%, of a maximum length of the chamfer along the central axis. For example, the first chamfer section extends at least partially in axial extension of the projections or the recesses.

According to a further embodiment of the screw element, it is provided that a diameter of the conical section is smaller than a vertex circle, wherein the vertices of all projections or recesses are arranged on the vertex circle. Preferably, the diameter of the conical section is about 70% to 95%, in particular 80%, or preferably between 90% and 94%, in particular 92% of the diameter of the vertex circle. The diameter of the conical section is in particular a diameter of a base area of the conical section or the maximum diameter of the conical section. Preferably, it is provided that the vertex circle is arranged in a vertex plane that is spaced along the central axis from a plane in which the largest area of the conical section lies. For example, the distance of the vertex plane and the plane is about half the maximum extension of the conical section along the central axis.

According to a further embodiment, it has proven particularly advantageous when it is provided that each of the projections is formed identically and/or that each of the recesses is formed identically. In particular, it is advantageous when the force application point is formed symmetrically to a symmetry axis. Preferably, the symmetry axis coincides with the central axis of the force application point and/or the central axis of the screw element. For example, it is provided that the force application point is formed rotationally symmetrical to the symmetry axis.

Insertion or placement of an actuating tool in any orientation into or onto the force application point is achieved when it is provided that the force application point has at least or exactly four, at least or exactly five, at least or exactly six projections and/or at least or exactly four, at least or exactly five, at least or exactly six recesses. The projections and the recesses are arranged uniformly, surrounding the central axis of the force application point. Thereby, for example, an actuating tool can be inserted into the force application point or placed onto the force application point in any orientation.

The invention further relates to an actuating tool for a screw element with a force application point, for example according to one of the described embodiments. The actuating tool has at least one actuating section with a plurality of projections and recesses arranged on a circumference around a central axis. The projections and the recesses merge into one another alternately. The projections and the recesses are formed with a curved shape. Furthermore, the projections and the recesses each extend parallel to the central axis in an insertion section.

The actuating tool is characterized in that a conical section is arranged in an end region of the force application point, and that a chamfer surrounding the conical section extends between the conical section and the insertion section. The actuating tool is preferably formed complementary to the described screw element with force application point. If the force application point of the screw element is formed as an internal profile, the actuating section of the actuating tool is formed as an external profile, and vice versa. In this respect, the described features of the screw element apply equally to the actuating tool, so that reference is made to the described features and embodiments. In particular, the actuating tool according to the invention has improved service life or durability through the chamfer. In particular, the actuating tool has at least a first and a second chamfer section with a first chamfer angle and a second chamfer angle.

To simplify the interaction of actuating tool and screw element, it is provided that the projections of the screw element correspond to the recesses of the actuating tool, and that the recesses of the screw element correspond to the projections of the actuating tool.

At a transition of the insertion section to a fastening or grip section opposite the end region of the force application point, the projections and/or the recesses can be arranged inclined to the central axis. Thereby, it is possible to simplify the manufacture of the actuating tool.

As an alternative to the conical section, it is provided that the actuating tool has a curved section instead of a conical section.

The invention further relates to a screw system that has at least one screw element with the features of one of the described embodiments and at least one actuating tool with the features of one of the described embodiments. Preferably, the force application point and the actuating section are formed such that the conical section of the actuating tool bears against the conical section of the force application point when the actuating section is fully inserted and/or that the chamfer of the actuating tool bears against the chamfer of the force application point.

Furthermore, the invention relates to the use of a profile with a plurality of projections and recesses arranged distributed on a circumference around a central axis. The projections and the recesses merge into one another alternately. The projections and the recesses are formed with a curved shape. Furthermore, the projections and the recesses each extend parallel to the central axis in an insertion section. A conical section is arranged in an end region. A chamfer surrounding the conical extends between the conical section and the insertion section. This profile is used as a force application point for a screw element or as an actuating section for an actuating tool. For the configuration of the profile within the framework of the screw element or the actuating tool, reference is made to the described features and embodiments.

Finally, the invention relates to a forming tool for manufacturing a force application point of a screw element or an actuating section of an actuating tool, in particular according to one of the described embodiments. Preferably, the force application point or the actuating section is formed as an internal profile or as an external profile with the described shape. For this purpose, the forming tool has a plurality of projections and recesses arranged distributed on a circumference around a central axis. The projections and the recesses merge into one another alternately. The projections and the recesses are formed with a curved shape. Both the projections and the recesses extend parallel to the central axis in an insertion section. A conical section is arranged in an end region of the force application point and a chamfer surrounding the conical section extends between the conical section and the insertion section.

For a configuration of the forming tool, reference is made to the described embodiments of the force application point of the screw element or the actuating section of the actuating tool as well as their features, which explicitly also apply to the forming tool. The forming tool is designed and configured such that it can manufacture the described force application points or actuating sections.

Further advantageous embodiments of the invention result from the following description of the figures and the claims.

### BRIEF DESCRIPTION OF THE DRAWINGS

FIG. 1 is a perspective view of an embodiment of a screw element in accordance with aspects of the invention;

FIG. 2 is a section view along the central axis of the embodiment of a screw element according to FIG. 1;

FIG. 3 shows an embodiment of a system comprising a screw element with an actuating tool in accordance with further aspects of the invention;

FIG. 4 shows a further embodiment of a system in accordance with aspects of the invention comprising a screw element and an actuating tool;

FIG. 5a shows a further embodiment of a screw element in accordance with aspects of the invention in section along the central axis;

FIG. 5b is a top view of the embodiment of a screw element according to FIG. 5a;

FIG. 6a is a partial section view along the central axis of a further embodiment of a screw element in accordance with aspects of the invention; and

FIG. 6b is a top view of the embodiment of a screw element according to FIG. 6a.

### DESCRIPTION OF THE PREFERRED EMBODIMENTS

In the various figures of the drawing, identical parts are provided with the same reference numerals.

For the following description, it is claimed that the invention is not limited to the embodiments and thereby not to all or several features of described feature combinations, rather each individual partial feature of the/each embodiment is also significant for the subject matter of the invention detached from all other partial features described in connection therewith and also in combination with any features of another embodiment.

In the illustrated figures, the axial direction A, the radial direction R and the circumferential direction U are formed as bidirectional directions, wherein for reasons of clarity only one direction is provided with an arrow. Furthermore, the axial direction A extends orthogonally to the radial direction R and parallel to a central axis M, M′.

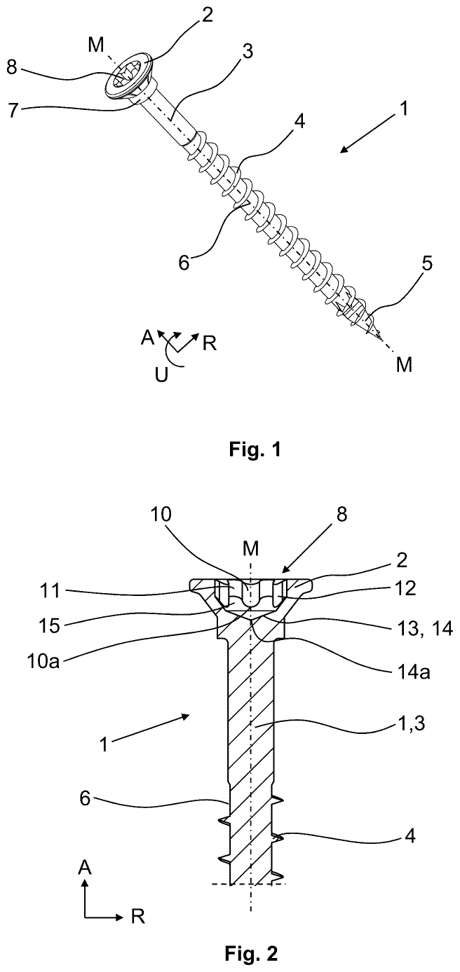

FIG. 1 shows an embodiment of a screw element 1 in perspective view. In this embodiment, the screw element 1 is formed as a universal screw. The screw element 1 has a screw head 2, a shank 3, a thread 4 as well as a screw tip 5. A thread root 6 of the thread 4 has a smaller diameter than the shank 3. In this embodiment, a substantially cylindrical shank projection 7 is formed in the transition between screw head 2 and shank 3. The shank projection 7 directly adjoins the screw head 2.

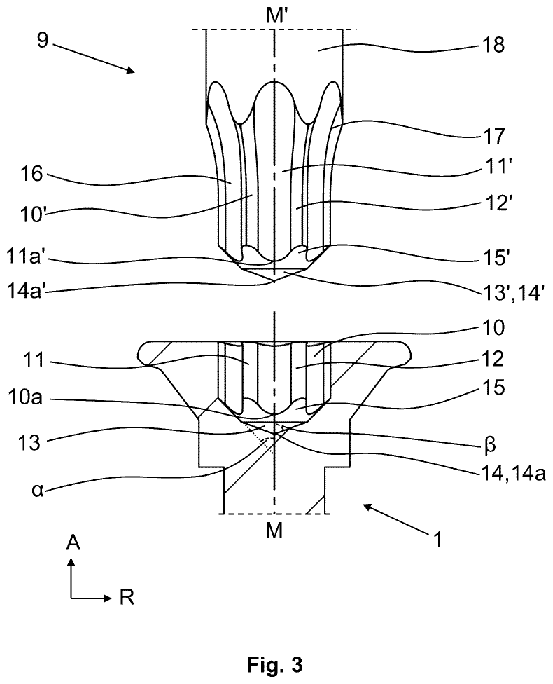

The screw element 1 has a force application point 8, which is shown in detail in a sectional view along a central axis M of the force application point 8 in FIGS. 2 and 3. The central axis M of the force application point 8 coincides with a central axis of the screw element 1. The force application point 8 serves for interaction with an actuating tool 9, which is shown by way of example in FIG. 3.

The force application point 8 of the screw element 1 has a plurality of projections 10 and recesses 11 distributed on a circumference around the central axis M and arranged alternately. The projections 10 and recesses 11 merge into one another alternately. Furthermore, the projections 10 and recesses 11 are formed with a curved shape. The projections 10 are curved convex to the central axis M and the recesses 11 are curved concave.

The projections 10 and recesses 11 each extend parallel to the central axis M in an insertion section 12. None of the projections 10 and none of the recesses 11 has an inclination to the central axis M. An imaginary enveloping circle at the vertices of the projections 10 has a constant diameter along the axial direction A. An imaginary enveloping circle around the recesses 11 also has a constant diameter along the axial direction A in the insertion section 12.

The force application point 8 has an end region 13, which is arranged in particular opposite to the insertion section 12. In the end region 13, a conical section 14 is arranged, which is formed as a cone tip. A tip 14a of the cone tip is arranged on the central axis M. Furthermore, the conical section 14 has a closed circumferential contour and is formed rotationally symmetrical to the central axis M.

Between the conical section 14 and the insertion section 12, a chamfer 15 is arranged. The chamfer 15 completely surrounds the conical section 14 in the circumferential direction U. The chamfer 15 has an inclination that deviates from an inclination of the conical section 14. In particular, the chamfer 15 encloses a smaller angle with the central axis M than the conical section 14. The chamfer 15 is formed rotationally symmetrical about the central axis M.

Because the conical section 14 in the end region 13 of the force application point 8 is combined with a chamfer 15 surrounding the conical section 14, the force application point has a double-chamfered tip. The surfaces of the projections 10 and recesses 11 are aligned parallel to the central axis M over their entire length up to the chamfer 15 in the screw element 1. In particular, all vertices of the projections 10 and recesses 11 each lie on an imaginary straight line that is aligned parallel to the central axis M.

The conical section 14 does not protrude beyond the chamfer 15 in the radial direction. The chamfer 15 surrounding the conical section 14 intersects both the projections 10 and the recesses 11. The insertion section 12 does not have an extension that extends in the axial direction A toward the end region 13 beyond the intersection surface of the chamfer 15 with a projection 10. The recesses 11 also end in the axial direction A toward the end region 13 of the force application point 8 where the chamfer 15 intersects the corresponding recess 11.

While the chamfer 15 transitions into the insertion section 12 in the direction of the insertion section 12, the chamfer 15 opens into the conical section 14 in the direction of the end region 13 of the force application point 8. The chamfer 15 is thus arranged directly adjacent to the insertion section 12 and directly adjacent to the conical section 14.

The chamfer 15, namely an outer surface of the chamfer 15, encloses a chamfer angle α with the central axis M, as shown in FIG. 3. Furthermore, the central axis M encloses a cone angle β with the conical section 14, namely with an outer surface of the conical section 14. The chamfer angle α is smaller than the cone angle β. The chamfer angle α is between 40° and 50°, in particular about 45°. The cone angle β is between 65° and 75°, in particular about 70°.

A maximum length of the chamfer 15 along the central axis M is greater than a maximum length of the conical section 14 along the central axis M. A length along the central axis M is in the present case a longitudinal extension in the axial direction A that is measured parallel to the central axis M. Furthermore, in the screw element 1 shown in FIGS. 1 and 2, a maximum length of the recesses 11 along the central axis M is greater than a maximum length of the chamfer 15 along the central axis M.

In particular according to FIG. 3, the chamfer 15 extends in extension, in particular of a vertex 10a, of the projections 10 and then opens into the conical section. A length of the chamfer 15 along the central axis M in extension of the projections 10, namely of a vertex 10a of the projections 10, is less than or equal to 25% of the maximum length of the chamfer 15 along the central axis M (see FIGS. 2 and 3). The chamfer 15 consequently has a first truncated cone-shaped section that intersects with the projections 10 and recesses 11 and a second truncated cone-shaped section that is not intersected by the projections 10 and recesses 11 (according to FIG. 3 below and adjacent to the conical section 14).

The vertices 10a of the projections 10 are arranged on a vertex circle. A maximum diameter of the conical section 14 is smaller than the vertex circle and corresponds here to about 80% of the diameter of the vertex circle. The vertex circle is thus somewhat larger than the diameter of the conical section 14. The force application point 8 has exactly six projections 10 and six recesses 11 in this embodiment.

FIG. 3 shows an embodiment of an actuating tool 9 that is designed to interact with the screw element 1 with a force application point 8. Together, the screw element 1 and the actuating tool 9 form a screw system.

The actuating tool 9 has an actuating section 16. The actuating section 16 is formed complementary to the force application point 8 of the screw element 1. The actuating section 16 has a plurality of projections 10′ and recesses 11′ arranged distributed on a circumference around a central axis M′. The projections 10′ of the actuating tool 9 are formed complementary to the recesses 11 of the screw element 1. The recesses 11′ of the actuating tool 9 are formed complementary to the projections 10 of the screw element 1.

The projections 10′ and the recesses 11′ of the actuating section 16 merge into one another alternately. The projections 10′ and the recesses 11′ are formed with a curved shape. In an insertion section 12′, the projections 10′ and the recesses 11′ extend parallel to the central axis M′. At a transition 17 from the insertion section 12′ to a fastening section 18, the projections 10′ and the recesses 11′ merge into a fastening section 18. In the transition 17, the projections 10′ and the recesses 11′ are formed with a curved shape and aligned inclined to the central axis M′.

Since the actuating tool 9 is formed complementary to the screw element 1 with the force application point 8, a maximum length of the projections 10′ along the central axis M′ is greater than a maximum length of the chamfer 15′ along the central axis M′. Furthermore, the chamfer 15′ extends in extension of the recesses 11′, here in extension of the vertices 11a′ of the recesses 11′. The chamfer 15′ has a first truncated cone-shaped section that intersects with the projections 10′ and recesses 11′, as well as a second truncated cone-shaped section that does not intersect with the projections 10′ and recesses 11′ and then transitions into the conical section 14′. A length of the chamfer 15′ along the central axis M′ in extension of the recesses 11′, here in extension of the vertices 11a′ of the recesses 11′, amounts to at most 25% of a maximum length of the chamfer 15′ along the central axis M′.

A diameter of the conical section 14′ is smaller than a diameter of a vertex circle on which the vertices 11a′ of all recesses 11′ lie and corresponds to about 92% of the diameter of the vertex circle. The diameter of the vertex circle is somewhat larger than the diameter of the conical section 14′. Also in this embodiment, the diameter of the conical section 14′ is the diameter of a base area of the conical section 14′ or the maximum diameter of the conical section 14′.

Both the force application point 8 according to the embodiment shown in FIGS. 1 to 3 and the actuating section 16 according to the embodiment of an actuating tool 9 shown in FIG. 3 have a double-chamfered tip. When the actuating tool 9 according to FIG. 3 is completely inserted with its actuating section 16 into the force application point 8 of the screw element 1, the conical section 14′ bears against the conical section 14 of the force application point 8 and the chamfer 15′ of the actuating section 16 bears against the chamfer 15 of the force application point 8. In addition, the projections 10′ and the recesses 11 as well as the recesses 11′ and the projections 10 work together to transmit torque about the central axis M.

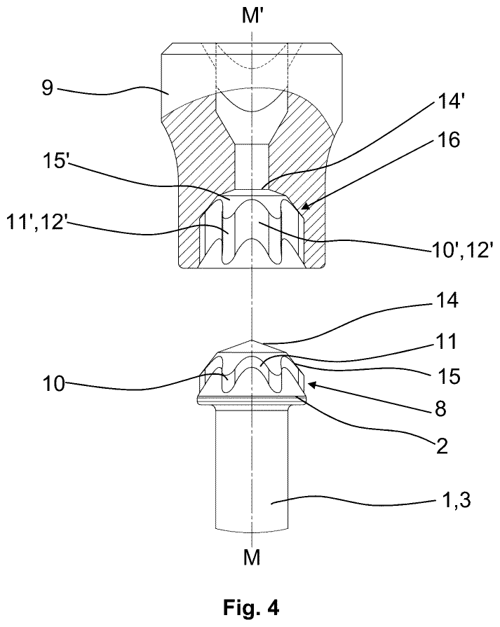

FIG. 4 shows a further embodiment of an actuating tool 9 that is designed to interact with the screw element 1 with a force application point 8. Together, the screw element 1 and the actuating tool 9 form a screw system. The actuating section 16 of the actuating tool 9 is formed as an internal profile, the force application point 8 of the screw element 1 as an external profile.

The actuating section 16 is formed complementary to the force application point 8 of the screw element 1. The actuating section 16 has a plurality of projections 10′ and recesses 11′ arranged distributed on a circumference around a central axis M′. The projections 10′ of the actuating tool 9 are formed complementary to the recesses 11 of the screw element 1. The recesses 11′ of the actuating tool 9 are formed complementary to the projections 10 of the screw element 1.

The projections 10′ and the recesses 11′ of the actuating section 16 merge into one another alternately. In an insertion section 12′, the projections 10′ and the recesses 11′ extend parallel to the central axis M′.

A chamfer 15′ extends in an end region in extension of the projections 10′. The chamfer 15′ has a first truncated cone-shaped section that intersects with the projections 10′ and recesses 11′, as well as a second truncated cone-shaped section that does not intersect with the projections 10′ and recesses 11′ and then merges into the likewise truncated cone-shaped section 14′. A length of the chamfer 15′ along the central axis M′ in extension of the projections 10′ amounts to at most 25% of a maximum length of the chamfer 15′ along the central axis M′.

A maximum diameter of the truncated cone-shaped section 14′ is smaller than a diameter of a vertex circle on which the vertices of all projections 10′ lie and corresponds to about 92% of the diameter of the vertex circle. The diameter of the vertex circle is somewhat larger than the maximum diameter of the conical section 14′.

The force application point 8 according to the embodiment shown in FIG. 4 has a double-chamfered tip. When the actuating tool 9 according to FIG. 4 is completely applied with its actuating section 16 onto the force application point 8 of the screw element 1, the truncated cone-shaped section 14′ bears against the conical section 14 of the force application point 8 and the chamfer 15′ of the actuating section 16 bears against the chamfer 15 of the force application point 8. In addition, the projections 10′ and the recesses 11 as well as the recesses 11′ and the projections 10 work together to transmit torque about the central axis M.

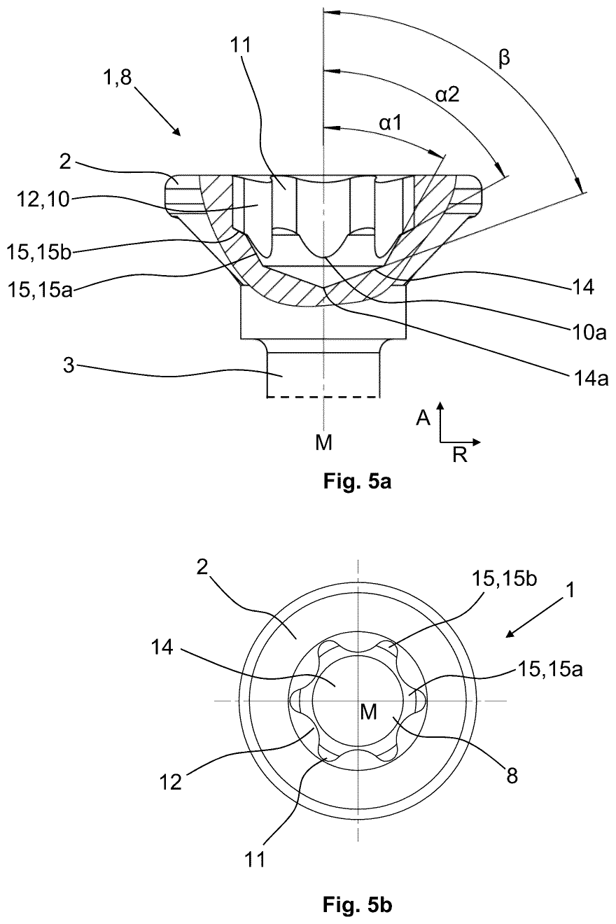

FIG. 5a shows a further embodiment of a screw element 1 in partial section along the central axis M. FIG. 5b shows the embodiment in a top view of the force application point 8. The screw element 1 is formed as a universal screw. Also in this embodiment, a substantially cylindrical shank projection 7 is formed in the transition between screw head 2 and shank 3. The shank projection 7 directly adjoins the screw head 2. It is also provided that the shank projection 7 has a different configuration. The central axis M of the force application point 8 coincides with a central axis of the screw element 1. The force application point 8 serves for interaction with an actuating tool 9, which is shown by way of example in FIG. 3.

The force application point 8 of the screw element 1 has a plurality of projections 10 and recesses 11 distributed on a circumference around the central axis M and arranged alternately. The projections 10 and recesses 11 merge into one another alternately. Furthermore, the projections 10 and recesses 11 are formed with a curved shape. The projections 10 are curved convex to the central axis M and the recesses 11 are curved concave.

The projections 10 and recesses 11 each extend parallel to the central axis M in an insertion section 12. None of the projections 10 and none of the recesses 11 has an inclination to the central axis M. The force application point 8 has an end region 13, which is arranged in particular opposite to the insertion section 12. In the end region 13, a conical section 14 is arranged, which is formed as a cone tip. A tip 14a of the cone tip is arranged on the central axis M. The projections 10 and recesses 11 are formed in particular as in the embodiments of FIGS. 2 and 3.

Between the conical section 14 and the insertion section 12, a chamfer 15 is arranged. The chamfer 15 completely surrounds the conical section 14 in the circumferential direction U. The chamfer 15 has a first chamfer section 15a and a second chamfer section 15b in this embodiment. The first chamfer section 15a is arranged adjacent to the conical section 14. A first chamfer angle α1 of the first chamfer section 15a is smaller than a second chamfer angle α2 of the second chamfer section 15b. The first chamfer angle α1 is about 28°, the second chamfer angle α2 about 62°. The chamfer 15 has a step due to the different chamfer sections 15a, 15b and is therefore formed single-stage.

The conical section 14 does not protrude beyond the chamfer 15 in the radial direction. The chamfer 15 surrounding the conical section 14 intersects both the projections 10 and the recesses 11. The insertion section 12 does not have an extension that extends in the axial direction A toward the end region 13 beyond the intersection surface of the chamfer 15, in particular of the first chamfer section 15a, with a projection 10. The recesses 11 also end in the axial direction A toward the end region 13 of the force application point 8 where the chamfer 15 intersects the corresponding recess 11. The cone angle β of the conical section 14 is between 65° and 75°, in particular about 70°.

The chamfer 15 extends in extension, in particular of a vertex 10a, of the projections 10 and then opens into the conical section 14. A length of the chamfer 15 along the central axis M in extension of the projections 10, namely of a vertex 10a of the projections 10, is less than or equal to 25% of the maximum length of the chamfer 15 along the central axis M.

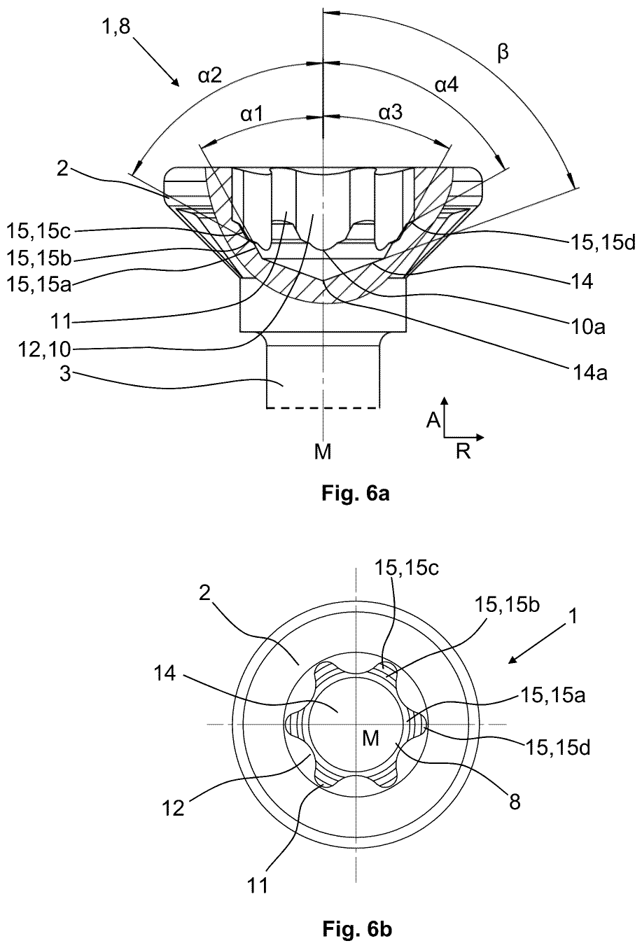

FIG. 6a shows a further embodiment of a screw element 1 in partial section along the central axis M. FIG. 6b shows the embodiment in a top view of the force application point 8. The embodiment is essentially formed like the embodiment of FIGS. 5a and 5b, with the difference that the chamfer 15 has, in addition to the first chamfer section 15a and the second chamfer section 15b, a third chamfer section 15c and a fourth chamfer section 15d. The third chamfer section 15c is inclined at a third chamfer angle α3 of about 28° to the central axis M. The fourth chamfer section 15d is inclined at a fourth chamfer angle α4 of about 62° to the central axis M. The first chamfer angle α1 and the third chamfer angle α3 as well as the second chamfer angle α2 and the fourth chamfer angle α4 are equal. Due to the four chamfer sections 15a, 15b, 15c, 15d, the chamfer 15 has two steps and is therefore formed two-stage. The cone angle β of the conical section 14 is between 65° and 75°, in particular about 70°.

The invention is not limited to the illustrated and described embodiments, but also encompasses all embodiments having the same effect within the meaning of the invention. It is expressly emphasized that the embodiments are not limited to all features in combination, rather each individual partial feature can also have inventive significance detached from all other partial features. Furthermore, the invention is also not yet limited to the feature combination defined in claim 1, but can also be defined by any other combination of specific features of all individually disclosed features. This means that in principle practically every individual feature of claim 1 can be omitted or replaced by at least one individual feature disclosed elsewhere in the application.

1. A screw element with a force application point for an actuating tool, wherein the force application point has a plurality of projections and recesses arranged distributed on a circumference around a central axis M, wherein the projections and the recesses merge into one another alternately, wherein the projections and the recesses are formed with a curved shape, and wherein the projections and the recesses each extend parallel to the central axis M in an insertion section, wherein a conical section is formed in an end region of the force application point, and that a chamfer surrounding the conical section extends between the conical section and the insertion section.

2. The screw element according to claim 1, wherein the chamfer surrounding the conical section intersects with at least one of the projections or the recesses.

3. The screw element according to claim 1, wherein the chamfer surrounding the conical section opens into the conical section.

4. The screw element according to claim 1, wherein a chamfer angle α that the chamfer encloses with the central axis M is smaller than a cone angle β that the conical section encloses with the central axis M of the force application point.

5. The screw element according to claim 1, wherein the chamfer has at least a first chamfer section and at least a second chamfer section, wherein the first chamfer section encloses a first chamfer angle with the central axis, and that the second chamfer section encloses a second chamfer angle with the central axis.

6. The screw element according to claim 5, wherein the chamfer has at least a third chamfer section and at least a fourth chamfer section, wherein the third chamfer section encloses a third chamfer angle with the central axis, and that the fourth section encloses a fourth chamfer angle with the central axis.

7. The screw element according to claim 1, wherein the chamfer is at least partially formed concave or convex curved.

8. The screw element according to claim 1, wherein a maximum length of the chamfer along the central axis M is greater than a maximum length of the conical section along the central axis M.

9. The screw element according to claim 1, wherein a maximum length of at least one of the recesses along the central axis M is greater than a maximum length of the chamfer along the central axis M.

10. The screw element according to claim 1, wherein the chamfer extends along the central axis in extension of one of the projections.

11. The screw element according to claim 10, wherein a length of the chamfer along the central axis in extension of one of the projections is at most 20% of a maximum length of the chamfer along the central axis.

12. The screw element according to claim 1, wherein a diameter of the conical section is smaller than the diameter of a vertex circle, and that vertices of the projections are arranged on the vertex circle.

13. The screw element according to claim 1, wherein the chamfer has a first section that is intersected by the projections and the recesses, and a second section that is not intersected by the projections or the recesses.

14. An actuating tool for a screw element with a force application point having at least one actuating section, wherein the actuating section has a plurality of projections and recesses arranged distributed on a circumference around a central axis, wherein the projections and the recesses merge into one another alternately, wherein the projections and the recesses are formed with a curved shape, wherein the projections and the recesses each extend parallel to the central axis in an insertion section, wherein a conical section is arranged in an end region of the actuating section and wherein a chamfer surrounding the conical section extends between the conical section and the insertion section.

15. The actuating tool according to claim 14, wherein the chamfer extends along the central axis M′ in extension of one of the recesses.

16. The actuating tool according to claim 14, wherein a diameter of the conical section is smaller than the diameter of a vertex circle, and wherein vertices of the recesses are arranged on the vertex circle.

17. The actuating tool according to claim 12, wherein a maximum length of one of the projections along the central axis is greater than a maximum length of the chamfer along the central axis.

18. Use of a profile with a plurality of projections and recesses arranged distributed on a circumference around a central axis M as a force application point for a screw element or as an actuating section of an actuating tool, wherein the projections and recesses merge into one another alternately, wherein the projections and the recesses are formed with a curved shape, wherein the projections and the recesses each extend parallel to the central axis M in an insertion section, wherein a conical section is arranged in an end region arranged opposite to the first section and wherein a chamfer surrounding the conical section extends between the conical section and the first section.

19. A forming tool for manufacturing a force application point of a screw element or an actuating section of an actuating tool wherein the forming tool has a plurality of projections and recesses arranged distributed on a circumference around a central axis, wherein the projections and recesses merge into one another alternately; wherein the projections and the recesses are formed with a curved shape, wherein the projections and the recesses each extend parallel to the central axis in an insertion section, wherein a conical section is arranged in an end region of the force application point and wherein a chamfer surrounding the conical section extends between the conical section and the insertion section.
